(19) United States
(12) Patent Application Publication
(10) Pub. No.: US 2008/0203885 A1
(43) Pub. Date: Aug. 28, 2008

(54) THERMAL-ELECTRON SOURCE

(75) Inventors: Tomio Ono, Kanagawa (JP); Tadashi Sakai, Kanagawa (JP); Naoshi Sakuma, Kanagawa (JP); Mariko Suzuki, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/851,095

(22) Filed: Sep. 6, 2007

(30) Foreign Application Priority Data
Feb. 28, 2007 (JP) 2007-049063

(51) Int. Cl. H01J 1/16

(52) U.S. Cl. 313/310

(57) ABSTRACT

A thermal-electron source includes a substrate; and a thermionic cathode having conductivity, and being provided on the substrate, and including a plurality of microscopic pores on a surface of the thermionic cathode.

### CROSS-REFERENCE TO RELATED APPLICATIONS

This application is based upon and claims the benefit of priority from the prior Japanese Patent Application No. 2007-49063, filed on Feb. 28, 2007; the entire contents of which are incorporated herein by reference.

### BACKGROUND OF THE INVENTION

1. Field of the Invention

The present invention relates to a thermal-electron source that emits thermal electron.

2. Description of the Related Art

A thermionic cathode using a thermal electron which is emitted from a material during heated to high temperature is used as an electron source of a vacuum tube such as an X-ray tube and a high-frequency electron tube that function in vacuum, and as an electron source of a discharge tube such as a fluorescent tube that functions in gas. A current density of the thermal electron in the thermionic cathode is determined based on a work function of the surface and an operating temperature, of the thermionic cathode. If the work function of the thermionic cathode material is decreased when the temperature is constant, a large current density can be obtained. On the other hand, if the work function of the thermionic cathode material is decreased when the current density is constant, the thermionic cathode can function at a low temperature.

In the vacuum, a lifetime of the thermionic cathode depends on an evaporation of the cathode material, so that it is possible to lengthen the lifetime by decreasing the operating temperature. Further lowering the operating temperature, electric powers required for heating can also be decreased. Although an oxide cathode, such as barium oxide (BaO)-based cathode, is widely used as the thermionic cathode that functions at a low temperature, it is still not sufficient to meet a currently increasing demand for a lower operating temperature.

As for a thermionic cathode that can be operated at a lower temperature, a technology for using, as the thermionic cathode material, an n-type semiconductor diamond with nitrogen or phosphorus doped is disclosed in JP-A H11-339632 (KOKAI).

However, even if the diamond is used as the thermionic cathode material, the thermionic cathode needs to be heated, resulting in a thermal damage due to heat radiation from the thermionic cathode on other members around the thermionic cathode. The thermal damage on the other members makes it difficult to realize an integration of the thermal-electron source and to realize a large-area thermal-electron source. Furthermore, because a power consumption of the thermal-electron source is large, a power efficiency of the thermal-electron source is degraded.

In addition, because a temperature of the thermionic cathode is required to reach a predetermined point to emit a thermal electron, the thermionic cathode can hardly make a prompt response to an applied current at a low temperature. Thus, the thermionic cathode needs to be heated constantly, and thermionic flow needs to be controlled by a grid electrode provided on the thermionic cathode. Therefore, the power consumption is increased due to a standby energy necessary for the constant heating, resulting in a degradation of the power efficiency of the thermal-electron source.

### SUMMARY OF THE INVENTION

According to one aspect of the present invention, a thermal-electron source includes a substrate; and a thermionic cathode having conductivity, and being provided on the substrate, and including a plurality of microscopic pores on a surface of the thermionic cathode.

### BRIEF DESCRIPTION OF THE DRAWINGS

FIG. 1A is a top view of a thermal-electron source according to a first embodiment of the present invention;

FIG. 1B is a side view of a thermal-electron source according to a first embodiment;

FIG. 2 is a side view of the thermal-electron source cut along a line A-A shown in FIG. 1A;

FIG. 3 is a schematic diagram of a structure of a microcavity light source according to the first embodiment;

FIG. 4 is a graph for explaining a relation between a light wavelength and radiant energy for an incandescent light source and the thermal-electron source according to the first embodiment;

FIG. 5 is a schematic diagram of a driving circuit for the thermal-electron source according to the first embodiment;

FIGS. 6A to 6G are sectional process diagrams of fabricating the thermal-electron source according to the first embodiment;

FIG. 7A is a top view of a thermal-electron source according to a second embodiment of the present invention;

FIG. 7B is a side view of a thermal-electron source according to a second embodiment;

FIG. 8 is a side view of the thermal-electron source cut along a line B-B shown in FIG. 7A; and

FIGS. 9A to 9F are sectional process diagrams of fabricating the thermal-electron source according to the second embodiment.

### DETAILED DESCRIPTION OF THE INVENTION

Exemplary embodiments of the present invention are explained in detail below with reference to the accompanying drawings. In the drawings, scales of each of members vary accordingly for convenience of explanation.

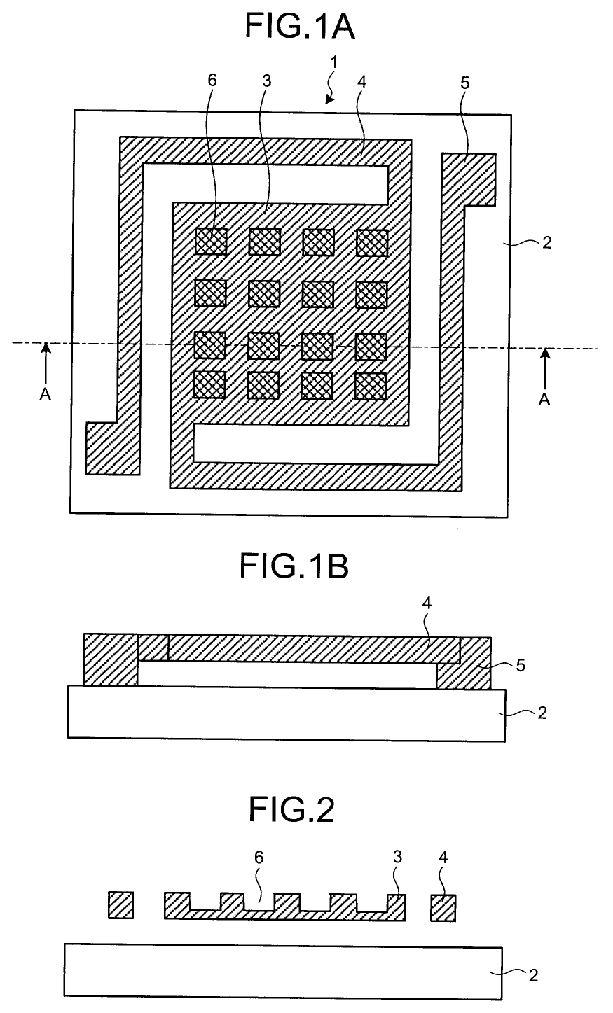

As shown in FIGS. 1A, 1B and 2, a thermal-electron source 1 includes a substrate 2, a thermionic cathode 3, a supporting member 4, and a fixing member 5.

The substrate 2 is made of silicon (Si). The thermionic cathode 3 emits thermal electron when the thermionic cathode 3 is heated by applying a current. The thermionic cathode 3 is made of an n-type polycrystalline diamond film with a thickness of about 8 micrometers, and includes a number of microcavities (microscopic pores) 6 on its top surface. Although the microcavity 6 is in a square shape in the example shown in FIGS. 1A, 1B and 2, a shape of the microcavity 6 is not thus limited and can be in rectangular or in circular shape. If the microcavity 6 is in a circular shape, a diameter of the pore is about 1 micrometer and a depth is in a range between 2 micrometers and 4 micrometers. A significance of the microcavity 6 will be described in detail later.

The supporting member 4 supports the thermionic cathode 3, and the fixing member 5 fixes the supporting member 4 to the substrate 2. Accordingly, the thermionic cathode 3 is configured in such a manner that the thermionic cathode 3 is separated from the substrate 2 and floated in the air by the supporting member 4 and the fixing member 5. The supporting member 4 and the fixing member 5 are made of the n-type polycrystalline diamond film, in the same manner as the thermionic cathode 3. However, other materials can be used for the supporting member 4 and the fixing member 5.

The significance of the thermionic cathode 3 that includes the microcavity 6 is described below. In the field of the incandescent light source, the next generation of an incandescent light source having high luminous efficiency (abbreviated as “incandescent light source”) called a microcavity light source is expected for a commercial use. The incandescent light source has a number of microcavities each having a diameter smaller than 1 micrometer on the surface of a filament. The diameter corresponds to half of a cutoff wavelength λc. The incandescent light source does not emit light having a wavelength longer than the cutoff wavelength λc when current is applied to the incandescent light source.

The incandescent light source and its emission property is examined and proposed by Waymouth. For example, a document, Seishi Sekine, Journal of the Illuminating Engineering Institute of Japan, vol. 87, p. 251, 2003, introduces the above proposal of the emission property and proposes detailed examination of the theory conducted by an author of the document.

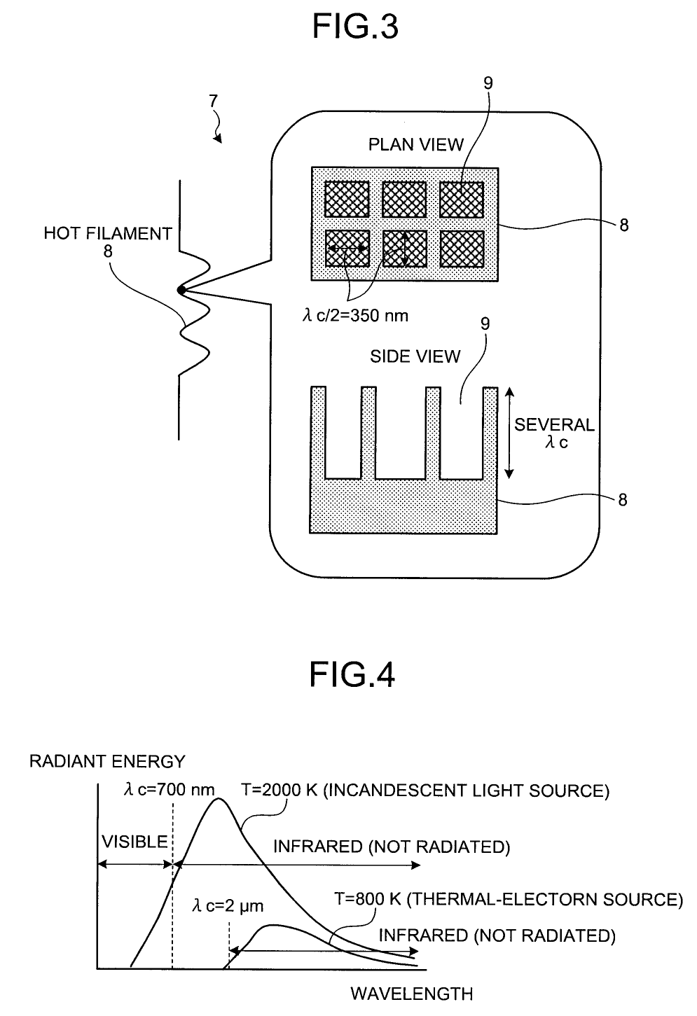

As shown in FIG. 3, a microcavity light source (an incandescent light source having high luminous efficiency) 7 includes a thermionic filament 8 made of tungsten (W) and a number of microcavities (microscopic pores) 9 on the top surface of the microcavity light source 7. The microcavity 9 is a square aperture serving as a waveguide tube with the cutoff wavelength λc of 700 nanometers. The cutoff wavelength λc on a side of the square aperture is λc/2=350 nanometers and a depth is in a range between one and five times of the cutoff wavelength λc.

With the microcavity 9 having the above configuration, photon having the cutoff wavelength λc or longer is not emitted, so that an infrared light having the wavelength of 700 nanometers or longer is not emitted, either. On the other hand, a visible light having the wavelength shorter than the cutoff wavelength λc is normally emitted from the microcavity 9. Therefore, the infrared light having the wavelength of 700 nanometers or longer is emitted exclusively from an external surface of an isolation wall between the adjacent microcavities 9. Accordingly, radiant quantity of the infrared light from the microcavity light source 7 is decreased compared to the radiant quantity from a normal incandescent light source (thermionic filament). As a result, power efficiency of the microcavity light source 7 is increased compared to the power efficiency of the normal incandescent light source (thermionic filament), from which most of the power supplied is lost due to the infrared radiation.

According to the graph shown in FIG. 4, with the incandescent light source of which filament temperature (T) reaches 2000K, most of the radiant energy is in a range corresponding to the infrared light with the cutoff wavelength λc of 700 nanometers or longer. Accordingly, the infrared radiation is suppressed without affecting the visible light, so that it is possible to improve the luminous efficiency.

The thermal-electron source according to the first embodiment is configured based on the above principle. In the normal thermal-electron source, an extra electric power for heating is required for compensating energy loss caused by the infrared radiation from the filament as the thermionic cathode and heat conduction by a supporting member of the filament; however, large amount of the infrared radiation occurs because the filament temperature is high (1000° C. or higher).

On the other hand, in the thermal-electron source 1, a number of the microcavities 6 are formed on the surface of the thermionic cathode 3, so that it is possible to suppress the infrared radiation even when the heating is performed by applying current via the fixing member 5. In this case, because a temperature of the filament is low compared with that of the incandescent light source, it is possible to suppress most of the infrared radiation, even when the wavelength of the infrared radiation is longer than that of the incandescent light source and the cutoff wavelength λc is lengthened. As shown in FIG. 4, if it is determined that the cutoff wavelength λc is 2 micrometers for the thermal-electron source of which filament temperature (T) reaches 800K, most of the infrared radiation can be suppressed.

Accordingly, the aperture diameter of the microcavity 6 can be such that is easily obtained through a semiconductor process, in units of micrometer. Although it is assumed that the aperture diameter of the microcavity 6 is about 1 micrometer according to the first embodiment, the aperture diameter can be changed appropriately depending on a ratio of the infrared radiation to be suppressed, a manufacturing process of the thermal-electron source or the like.

The thermionic cathode 3 is made of the n-type polycrystalline diamond film capable of easily emitting the electron to a thermionic cathode material, and has an operating temperature (between 400° C. and 600° C.) lower than that of the normal thermal-electron source, so that a deforming of a cavity structure caused by high temperature, which is a common problem in the microcavity light source, hardly occurs. Furthermore, the thermionic cathode 3 has less heat discharge owing to the suppression of the infrared radiation, has a low operating temperature, and is configured in such a manner that the thermionic cathode 3 is separated from the substrate 2 and floated in the air, so that the energy loss due to the heat conduction via the supporting member 4 can be suppressed.

In this manner, less power is required for heating the thermal-electron source 1, so that the power consumption of the thermal-electron source 1 can be reduced, resulting in improving the power efficiency. Furthermore, the infrared radiation emitted from the thermionic cathode is suppressed and the heat discharge can be reduced, so that it is possible to reduce a thermal damage on the other members provided around the thermionic cathode. Accordingly, the thermal-electron source 1 is suitable for realizing an integration of the thermal-electron source and realizing the large-area thermal-electron source. Thus, the above characteristics are advantageous for realizing the large-area electron source, such as a flat display, in which the electron source is integrated, or an electron beam exposure device.

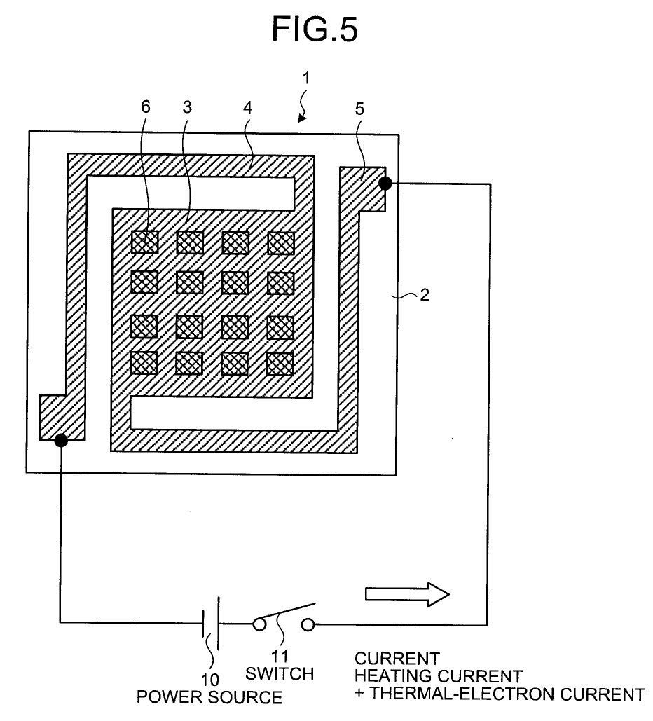

In the example shown in FIG. 5, a power source 10 is connected to the thermal-electron source 1 and a switch 11 capable of turning ON/OFF of the current is provided between the thermal-electron source 1 and the power source 10.

For the normal thermal-electron source, it is necessary to raise the temperature of the thermal-electron source, so that it takes time for the thermal-electron source to be in an operable state after turning ON the thermal-electron source, resulting in failing to make a prompt response. Therefore, as a general method for using the thermal-electron source, the thermionic cathode is constantly heated and thermionic current is controlled by a grid electrode provided on the thermionic cathode. With the normal thermal-electron source, power efficiency is low due to standby energy necessary for the constant heating.

On the other hand, according to the first embodiment, because energy loss caused by the infrared radiation and the heat conducting of the thermal-electron source 1 are suppressed, the operating temperature of the thermal-electron source 1 is low, and heat capacity of the thermal-electron source 1 is small owing to the microscopic size of the thermal-electron source 1, it is possible to raise the temperature at a high speed by applying current without performing the constant heating, so that the thermionic current is turned ON.

On the other hand, for turning OFF the thermionic current by lowering the temperature of the thermal-electron source, because the energy loss of the thermal-electron source 1 hardly occurs, it is difficult to make a prompt response with the conventional method of turning OFF the thermionic current. According to the first embodiment, a method is employed, in which the switch 11 is provided between the thermal-electron source 1 and the power source 10, so that the power supply to the thermal-electron source 1 can be stopped by turning OFF the switch 11, resulting in forcibly turning OFF the thermionic current of the thermal-electron source 1.

As a result, the standby energy is not necessary in the thermal-electron source 1, because the thermal-electron source 1 can make a prompt response by applying current without the constant heating, so that power consumption can be reduced, resulting in improving the efficiency of the power in the thermal-electron source 1.

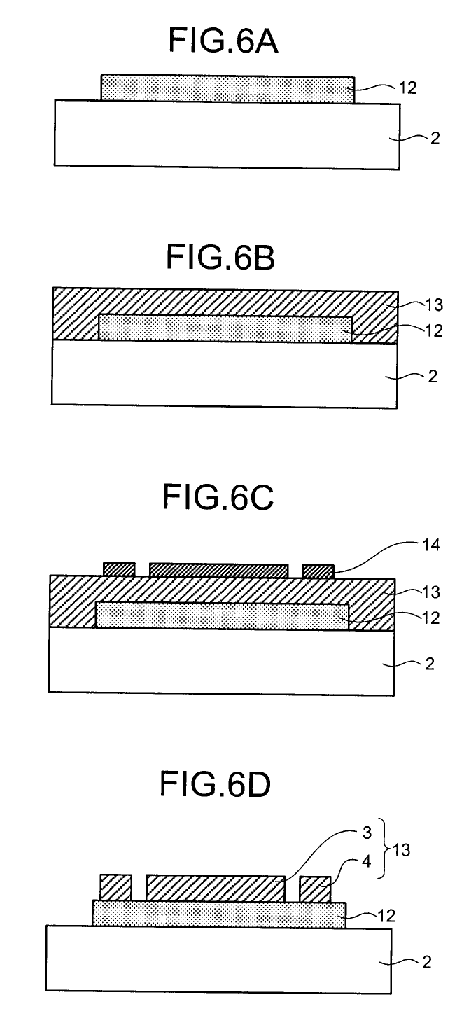

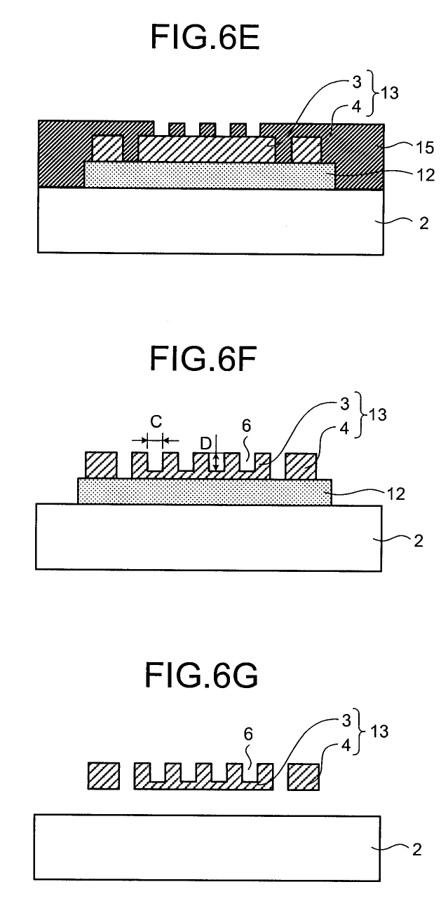

A manufacturing method of the thermal-electron source 1 is described below. FIGS. 6A to 6G are side views of the thermal-electron source 1 cut along a line A-A shown in FIG. 1. First, as shown in FIG. 6A, the substrate 2 made of Si is prepared, a silicon dioxide (SiO2) film 12 as a sacrifice layer is subsequently formed, and patterning is performed.

Subsequently, an n-type polycrystalline diamond film 13 with the thickness of about 8 micrometers is formed by the microwave plasma chemical vapor deposition (CVD) method, as shown in FIG. 6B. The growth condition of the n-type polycrystalline diamond film 13 is such that microwave power is 1.5 kW, hydrogen flow rate is 200 standard cubic centimeters per minute (sccm), methane gas flow rate is 4 sccm, and methane concentration in material gas is 2%. The material gas pressure is 80 Torr, and the substrate is heated to 750° C. As for an n-type dopant, phosphorus is used, and hydrogen phosphide (PH3) gas is simultaneously supplied at the time of the diamond film growth.

An aluminum (Al) film is formed and a first mask 14 is subsequently formed by performing the patterning as shown in FIG. 6C. With the first mask 14, an anisotropic etching using an reactive ion etching (RIE) is performed for the n-type polycrystalline diamond film 13. The RIE is performed using carbon tetrafluoride (CF4) gas and oxygen (O2) gas, and thereafter, the first mask 14 is removed. As a result, the n-type polycrystalline diamond film 13 is divided into the thermionic cathode 3 and the supporting member 4 as shown in FIG. 6D.

The Al film is formed again, so that a patterning is performed to form a second mask 15, as shown in FIG. 6E. With the second mask 15, the anisotropic etching using the RIE is performed to the portion corresponding to the thermionic cathode 3 of the n-type polycrystalline diamond film 13, and thereafter, the second mask 15 is removed. As a result, a number of the microcavities 6 having an aperture diameter C of about 1 micrometer and a depth D in a range between 2 micrometers and 4 micrometers are formed, as shown in FIG. 6F. Subsequently, the SiO2 film 12 as the sacrifice layer is removed, so that the thermal-electron source 1 is completed as shown in FIG. 6G.

As described above, with the thermal-electron source according to the first embodiment, a number of the microcavities are provided on the thermionic cathode, so that the infrared radiation from the thermionic cathode is suppressed and the heat discharge is reduced, resulting in reducing a thermal damage on the other members around the thermal-electron source. As a result, it is possible to realize an integration of the thermal-electron source and the large-area thermal-electron source.

Furthermore, because a number of the microcavities are provided on the thermionic cathode, the infrared radiation from the thermionic cathode is suppressed, and radiation amount is reduced, it is possible to reduce the power consumption of the thermal-electron source.

Moreover, the thermionic cathode is configured in such a manner that the thermionic cathode is separated from the substrate and floated in the air, so that energy loss due to the heat conducting via the supporting member can be reduced, resulting in reducing the power consumption.

Furthermore, the thermionic cathode is made of an n-type diamond, so that the operating temperature can be lowered. Accordingly, it is possible to reduce power necessary for heating, resulting in reducing the power consumption.

Moreover, the thermal-electron source can respond in an expedited manner by applying current without the constant heating, so that standby energy is not needed, resulting in reducing the power consumption.

A thermal-electron source according to a second embodiment is described below with reference to the accompanying drawings. The thermal-electron source according to the second embodiment is different from the first embodiment in that the thermionic cathode is configured to include a reflector on a lower portion of the thermionic cathode. The configuration of the thermal-electron source according to the second embodiment different from the configuration of the first embodiment is exclusively described. The members assigned with the same reference numerals as those in the first embodiment function similarly to those in the first embodiment, and therefore, explanations thereof are omitted.

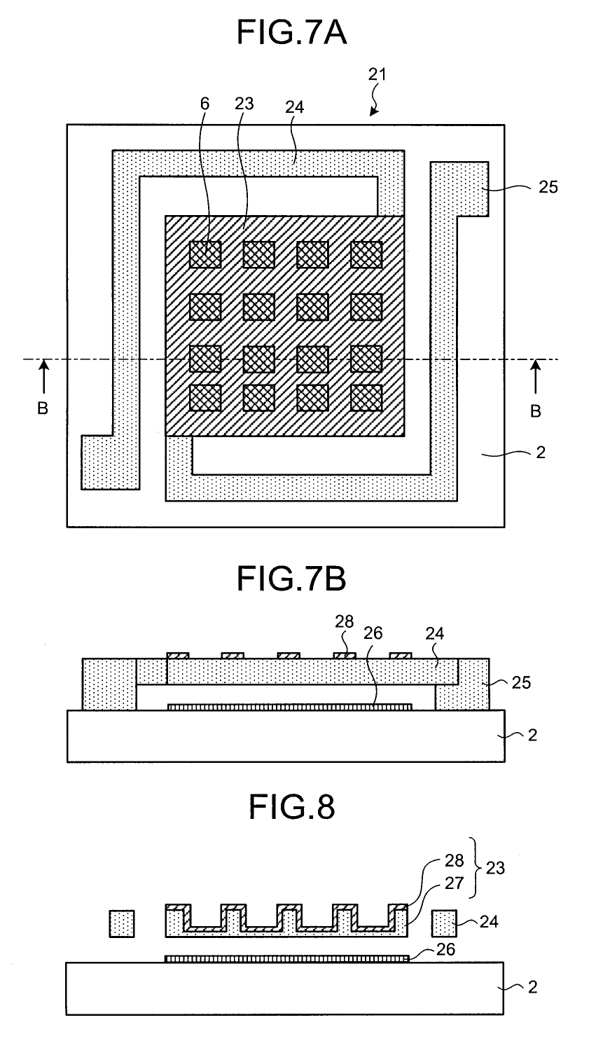

As shown in FIGS. 7A, 7B and 8, a thermal-electron source 21 includes the substrate 2, a thermionic cathode 23, a supporting member 24, a fixing member 25, and a reflector 26.

The thermionic cathode 23 emits the thermal electron when current is applied to the thermionic cathode 23 to heat the thermionic cathode 23. The thermionic cathode 23 includes a polysilicon film 27 that has a thickness of about 8 micrometers and on the top surface of which a number of the microcavities 6 are formed, and an n-type nanodiamond film 28 that has the thickness of about 100 nanometers and is formed on the polysilicon film 27. In this manner, with the nanodiamond film capable of performing a low-temperature growth used as a material for the thermionic cathode, it is possible to manufacture the thermal-electron source 21 more flexibly.

The supporting member 24 supports the thermionic cathode 23. The fixing member 25 fixes the supporting member 24 to the substrate 2. Accordingly, the thermionic cathode 23 is configured in such a manner that the thermionic cathode 23 is separated from the substrate 2 and floated in the air. In the second embodiment, the supporting member 24 and the fixing member 25 are made of polysilicon film in connection with the method of manufacturing the thermal-electron source 21. However, the supporting member 24 and the fixing member 25 can be made of other materials. The reflector 26 is provided on the substrate 2 in such a manner that the size of the reflector 26 approximately corresponds to the size of the thermionic cathode 23 provided over the reflector 26, and reflects the infrared radiation from the bottom surface of the thermionic cathode 23. The reflector 26 is made of tungsten (W).

With the reflector 26 provided, the infrared radiation from the bottom portion of the thermionic cathode 23 is reflected by the reflector 26 and returns to the thermionic cathode 23. Therefore, it is possible to reduce a thermal damage on the substrate 2, resulting in realizing the integration of the thermal-electron source and the large-area thermal-electron source.

Furthermore, the thermionic cathode 23 is heated by the reflected infrared radiation, so that the temperature of the thermionic cathode 23 can be raised promptly.

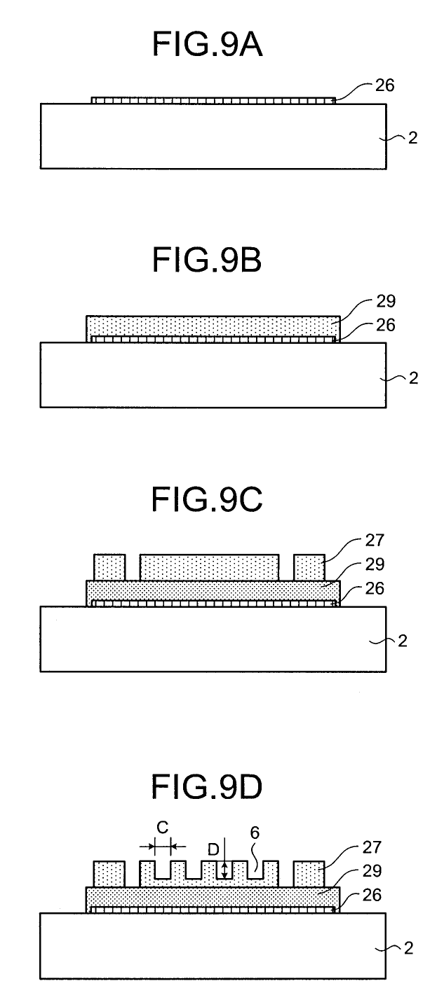

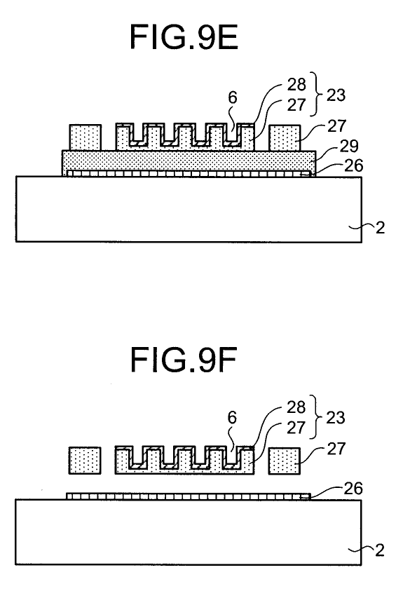

A manufacturing method of the thermal-electron source 21 is described below. FIGS. 9A to 9F are side views of the thermal-electron source 21 cut along a line B-B shown in FIG. 7A. First, the Si substrate 2 is prepared as shown in FIG. 9A, a W layer to be the reflector 26 is formed on the top surface of the substrate 2, and patterning is performed as shown in FIG. 9A. A phosphosilicate glass (PSG) 29 is formed and a patterning is performed as shown in FIG. 9B.

Subsequently, the polysilicon film 27 with the thickness of about 8 micrometers is formed. The first mask is further formed, the anisotropic etching using the RIE is performed, and the first mask is removed. For the first mask, the Al film is used. As a result, the polysilicon film 27 is divided into a portion constituting the thermionic cathode 23 and the shape including the supporting member 24, as shown in FIG. 9C.

Thereafter, the second mask is formed, the anisotropic etching using the RIE is performed, and the second mask is removed. For the second mask, the Al film is used. As a result, a number of the microcavities 6 with the aperture diameter C of 1 micrometer and the depth D in a range between 2 micrometers and 4 micrometers are formed on the polysilicon film 27 corresponding to the portion constituting the thermionic cathode 23, as shown in FIG. 9D.

The thin n-type nanodiamond film 28 with the thickness of about 100 nanometers is formed on a portion of the polysilicon film 27 corresponding to the portion constituting the thermionic cathode 23, by the microwave plasma CVD method, as shown in FIG. 9E. Although the n-type polycrystalline diamond film 13 is formed using methane gas and hydrogen gas according to the first embodiment, the n-type nanodiamond film 28 is formed using methane and argon gas. In addition, although the size of the n-type polycrystalline diamond film 13 is generally in units of micrometer, the size of the crystal grain of the n-type nanodiamond film 28 is in units of nanometer. Therefore, the thin film used in the second embodiment can be formed with the n-type nanodiamond film 28, with a preferable coatability for the irregularity of the surface and capability of forming the film at a low temperature between 200° C. and 400° C. As for the n-type dopant, nitrogen is used, and nitrogen (N2) gas is simultaneously supplied at the time of the diamond film growth.

Although a process for forming a third mask on a portion where the n-type nanodiamond film 28 is not formed is necessary before the above process, and a process for removing the third mask is further necessary after the above process, detailed explanations thereof are omitted.

As shown in FIG. 9F, the PSG film 29 as the sacrifice film is removed, so that the thermal-electron source 21 is completed.

As described above, with the thermal-electron source according to the second embodiment, the reflector capable of reflecting the infrared radiation emitted from the thermionic cathode to the substrate is provided, so that the radiation amount to be absorbed by the substrate can be reduced, resulting in reducing the thermal damage on the substrate. As a result, it is possible to realize the integration of the thermal-electron source and the large-area thermal-electron source.

Furthermore, with the reflector provided, the thermionic cathode 23 is heated by the infrared radiation reflected by the reflector, so that the temperature of the thermionic cathode 23 can be raised promptly. As a result, power necessary for the heating can be reduced, resulting in reducing the power consumption.

Moreover, the nanodiamond film capable of performing the low-temperature growth is used as the material for the thermionic cathode, so that the thermal-electron source can be flexibly manufactured.

The present invention is not limited to the above embodiments. For example, although the substrate made of Si is used according to the first and the second embodiments, a substrate made of glass can be alternatively used. If a glass substrate is used, a thermal-electron source having large-area can be more easily manufactured. In addition, various modifications can be applicable without departing from the sprits and the scope of the present invention.

According to an aspect of the present invention, it is possible to realize the integration of the thermal-electron source and the large-area thermal-electron source. Furthermore, the power consumption of the thermal-electron source can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A thermal-electron source comprising:
a substrate; and
a thermionic cathode having conductivity, and being provided on the substrate, and including a plurality of microscopic pores on a surface of the thermionic cathode.

2. The thermal-electron source according to claim 1, wherein a diameter of an aperture portion of the microscopic pore corresponds to half of a predetermined wavelength of infrared light.

3. The thermal-electron source according to claim 1, wherein a diameter of an aperture portion of the microscopic pore is 1 micrometer and a depth of the aperture portion is between 2 micrometers and 4 micrometers.

4. The thermal-electron source according to claim 1, further comprising a supporting member that is provided between the substrate and the thermionic cathode to support the thermionic cathode in a state of floating from the substrate, the supporting member supplying current to the thermionic cathode and suppressing heat conduction from the thermionic cathode to the substrate.

5. The thermal-electron source according to claim 1, further comprising a reflector that is provided between the substrate and the thermionic cathode and reflects infrared radiation from the thermionic cathode.

6. The thermal-electron source according to claim 4, further comprising:
a power source that is connected to the supporting member and supplies current to the thermionic cathode; and
a switch that is connected to the supporting member and blocks the current flown.

7. The thermal-electron source according to claim 1, wherein the thermionic cathode includes an n-type diamond.

8. The thermal-electron source according to claim 1, wherein the thermionic cathode includes silicon and an n-type diamond formed on a surface of the silicon, an opposite surface of the silicon facing the substrate.
